(19) United States
(12) Patent Application Publication
(10) Pub. No.: US 2020/0366387 A1
(43) Pub. Date: Nov. 19, 2020

(54) DETERMINING MICROPHONE PERFORMANCE BASED ON AMBIENT SOUNDS

(71) Applicant: SIGNIFY HOLDING B.V., EINDHOVEN (NL)

(72) Inventors: Edith Danielle DEN HARTOG, EINDHOVEN (NL); Ralf Gertruda Hubertus VONCKEN, EINDHOVEN (NL)

(21) Appl. No.: 16/638,891

(22) PCT Filed: Aug. 9, 2018
(86) PCT No.: PCT/EP2018/071654

§ 371 Date: Feb. 13, 2020

(30) Foreign Application Priority Data
Aug. 17, 2017 (EP) 17186538.9

(51) Int. Cl. H04B 17/318; H04R 3/04; H04R 3/00; H04R 5/04

(52) U.S. Cl. CPC H04B 17/318; H04R 5/04; H04R 3/005; H04R 3/04

(57) ABSTRACT

According to one aspect disclosed herein, there is provided a method of tracking the performance of a microphone forming part of an audio based monitoring system comprising a network of microphones distributed throughout an environment, the method comprising: detecting a first instance of an environmental sound at the microphone; determining that the environmental sound is a recurring environmental sound; capturing a reference signal from the detected first instance of the environmental sound; detecting a subsequent instance of the same environmental sound at the same microphone; and comparing at least in part the subsequent instance of the environmental sound to the reference signal to determine an indication of the performance of the microphone.

### TECHNICAL FIELD

The present disclosure relates to monitoring performance of a microphone forming part of an audio based monitoring system comprising a network of microphones.

### BACKGROUND

Outdoor lighting networks are becoming smarter, in part due to them comprising more sensors. Given the high density of acoustic sensors in an outdoor lighting network compared to typical outdoor acoustic sensing solutions, certain new use cases can be supported.

One such extension is to exploit sensors of the lighting system to provide a surveillance system, wherein various sensors (e.g. microphones) installed at light points can be used to provide part of the input for those who are responsible for cities' public safety (e.g. police and law enforcement agencies). The information obtained by such surveillance systems can be used to make public areas safer and to enable law enforcement teams work safer and more efficiently.

These acoustic real-time safety monitoring (acoustic RTSM) solutions are capable of detecting possible events that may affect the public safety (e.g. gunshots, fighting, breaking glass, graffiti, etc.).

### SUMMARY

Acoustic monitoring systems (e.g. RTSM systems) are currently capable of detecting a potential event at a certain location. These systems can detect e.g. gunshots, fighting, breaking glass and graffiti. Information relating to such events may be gathered in the form of audio and video. Subsequently the information gathered may be used to inform emergency services of current and potential situations in need of attention. These might include victims in need of help and looking for a safe area, or a fleeing potential suspect who should be pursued. Such a monitoring system is fully dependent on the quality of the audio monitoring, and thus dependent on the microphones used therein. It is known to analyse microphone output against audio input in a test environment. However, when the microphones in need of testing form part of an already deployed system such an analysis is not a favourable way to test the performance of a microphone. The present application discloses a suitable method for tracking microphone performance and potential faults in microphones within such a monitoring system. This tracking is performed by determining an ambient reference signal sound from a pre-existing source in the surroundings of the microphone, and then comparing future instances of the same sound against this reference signal.

Hence, according to a first aspect disclosed herein, there is provided a method of tracking the performance of a microphone forming part of an audio based monitoring system comprising a network of microphones distributed throughout an environment, the method comprising: detecting a first instance of an environmental sound at the microphone; determining that the environmental sound is a recurring environmental sound; capturing a reference signal from the detected first instance of the environmental sound; detecting a subsequent instance of the same environmental sound at the same microphone; and comparing at least in part the subsequent instance of the environmental sound to the reference signal to determine an indication of the performance of the microphone.

The environmental sound is a sound emitted from a source within the environment or in close proximity to the environment, e.g. across the street, in the next street, on the next block, on the other side of the building, etc. from the source. Thus by making use of a repeating, incidental sound that happens to be present in the environment independently of the audio monitoring system, it is possible to exploit this sound to monitor performance of one or more microphones of the system. An example of an environmental sound that could be used for this is, for instance, a church bell or bells.

In embodiments, the comparison is performed by analysing an amplitude and/or frequency over time for the first and subsequent instances of the environmental sound. For example, this may comprise analysing their sound spectra over time.

The capturing could take the form of storing an exact recording of the first instance, or could be performed by extracting a signature (e.g. spectrum), and capturing the signature. That is to say the first instance of the environmental sound could be captured as a sound recording, or the first instance of the sound could be captured as a representation of the sound, e.g. a spectrum.

In embodiments, such a sound spectrum is created by analysing the amplitude and/or the frequency over time.

In embodiments, the reference signal is created by storing the sound spectrum of the first instance of the environmental sound.

In embodiments, the analysis is performed at intervals within a period of time over which the environmental sound is detected.

For example, the intervals may be five times in every two seconds, ten times in every two seconds, once every 0.4 seconds, and/or once every 0.2 seconds.

In embodiments, the intervals are evenly spaced over the period of time.

In embodiments, the environment spans an area of the scale of at least one city block, and/or one building, and/or one street, and/or one town square, and/or one school campus, and/or one town.

In embodiments, the determining includes using sound recognition to identify a type of a source of the environmental sound.

In embodiments, the type of source does not have a different location relative to the environment when emitting any subsequent instance of the environmental sound.

For example, the sound emanates from a source which does not move relative to the environment, and thus the sound will not be expected to change in amplitude outside of known conditions such as changes in weather. E.g. the source is not an ice cream truck, which may never park in the same place twice. But it could be a bus which always stops at the same bus stop.

In embodiments, the determining comprises using sound recognition to recognise that the environmental sound is a sound which is repeated periodically.

For example, the audio characteristics of a church bell ringing will be recognized using sound recognition, where the church bell sound can then be identified as a church bell and determined to be suitable for use in creating the reference signal. In embodiments, the subsequent instance of the environmental sound is recognised using a sound recognition algorithm applied to recognize a sound signature of the first instance of the environmental sound.

In embodiments, the sound signature comprises a frequency profile of the sound.

In embodiments, the comparison comprises comparing sound spectra of the first and subsequent instances of the environmental sound.

For example the comparison may comprise performing a comparison between amplitudes of one or more frequency components, or a comparison of a frequency profile across a frequency range of the environmental sound and/or an overall comparison between frequency characteristics across a whole frequency range of the environmental sound.

E.g. the comparison may compare a specific frequency or range of frequencies which have changed in amplitude in the subsequent instance of the environmental sound when compared to the reference signal, or an overall shift in frequency of the subsequent instance of the environmental sound when compared to the reference signal.

In embodiments, the comparison takes into account environmental conditions at the microphone at the time of the subsequent environmental sound relative to environmental conditions at the microphone at the time of the first instance of the environmental sound.

E.g. if the microphone is in a location particularly exposed to the weather (e.g. wind, rain, sun) the comparison may take into account the weather conditions; or if it is in a location where traffic levels, and therefore noise levels, fluctuate at different times and on different days (e.g. weekday vs weekend), then the comparison may take into account the traffic level.

The indication of performance may comprise a detected change in performance, i.e. a reduction in and/or an increase in, or no detected change in performance, based on comparing parameters of the sound spectrum of the environmental sound to parameters of the sound spectrum of the reference signal.

The indication of performance may be a level of performance based on the magnitude of the detected change in performance. E.g. a change in performance of 0% is level 1—no deviation, 0-5% is level 2—low deviation, 5-10% is level 3, 25-50% is level 5—very high deviation etc.

The level of performance may be output as a notification comprising a level of importance and wherein the level of importance may be adjusted to account for the specific conditions at the microphone being tracked. For example, Level 1 is ‘negligible’ or ‘worrying’. Level 5 is ‘expected’ or ‘critical’. The specific conditions accounted for may include the level of risk within the immediate area of the location of the microphone, e.g. if this is where incidents often occur, such that an accurate measure of sound may be vital.

According to a second aspect disclosed herein, there is provided a computer program product comprising code embodied on computer-readable storage and configured so as when run on a computer system to perform the operations according to any of the embodiments disclosed herein.

According to a third aspect disclosed herein, there is provided a computer system comprising storage comprising one or more memory units, and processing apparatus comprising one or more processor units, the storage storing code and the processing apparatus being arranged to run the code, wherein the code is configured so as when run on the processing apparatus to perform the operations of the embodiments disclosed herein.

For example, the controller and its sound recognition engine may be implemented in software stored on one or more storage units employing one or more storage media (e.g. magnetic, electronic, or optical media), and arranged to run on one or more processors. The controller and its sound recognition engine may be implemented on one device (in the same housing) or across multiple devices, e.g. embedded in the luminaire or microphone or at a central server, or a combination of such approaches.

### BRIEF DESCRIPTION OF THE DRAWINGS

To assist understanding of the present disclosure and to show how embodiments may be put into effect, reference is made by way of example to the accompanying drawings in which:

FIG. 1 schematically illustrates a plan of a smart city equipped with a network of microphones,

FIG. 2 is a schematic block diagram of an acoustic monitoring system, and

FIG. 3 shows an example of a sound spectrum for an environmental sound.

### DETAILED DESCRIPTION OF EMBODIMENTS

Current typical surveillance monitoring solutions are either video-based or based on video and sound sensing. In existing systems where sound is included, it offers only a one-off alarm based on a single acoustic trigger. The triggers are individual and tend to include a small number of random loud acoustic event types and several less loud event types. However, the quality of the recording becomes more important when the acoustic content is being used to specifically monitor an event and subsequently provide situationally relevant information. For example in the discussed monitoring system that uses detected sounds in this way, the sound detected by a microphone may be used to determine the distance or direction of a detected sound event, as well as for categorizing such a detected sound event. If the microphone does not perform as expected, the information derived from the detected sound may no longer be reliable. For example, inaccurate frequency values of sounds may be captured, such that they no longer faithfully represent the sound as created within the environment, and this may have a detrimental impact when it comes to identifying the source or type of sound. Further to this, capturing inaccurate amplitude levels of sounds may have a detrimental impact when trying to determine the location of the source of the sound, e.g. the point of origin of a gunshot. The following discloses a method for tracking the performance of microphones distributed within such a monitoring system. As a result microphones within such a system can be maintained more easily, remotely, more frequently, and/or at a lower cost to the maintenance provider. Thus there can be a certain assurance of quality associated with the output of the microphones. Consequently, inadequate performance of a microphone is less likely, and determination of inaccurate information about a scenario being monitored by the monitoring system is less likely to be provided to third parties, e.g. emergency services.

The above mentioned acoustic monitoring solution (e.g. an acoustic RTSM) is capable of detecting possible incidents that affect the public safety, meaning that the performance of these microphones is crucial in order for the system to detect potential incidents accurately. However, these microphones must perform in an ever-changing outdoor environment where a lot of external factors could damage or effect the performance of the microphone. The main causes of a microphone underperforming include: rapid changes in humidity, rain and moisture, animals, wind, smoke (fire, smog, and/or pollution), movement (e.g. sudden impacts), dust, heat (too warm, too cold), ice, animals (birds, insects) and sunlight degradation. The disclosed system allows for a fast and easy system that checks the performance of the microphones remotely.

It not always clear when the performance of a microphone such as a luminaire based microphone has been adversely affected. Thus a performance problem can go unnoticed for a significant amount of time, particularly if manual performance checks are few and far between. Checking the microphones' performance manually is also very time consuming and costly. However such checks are crucial for sound based incident detection algorithms and thus crucial for the system to work at the high standards required.

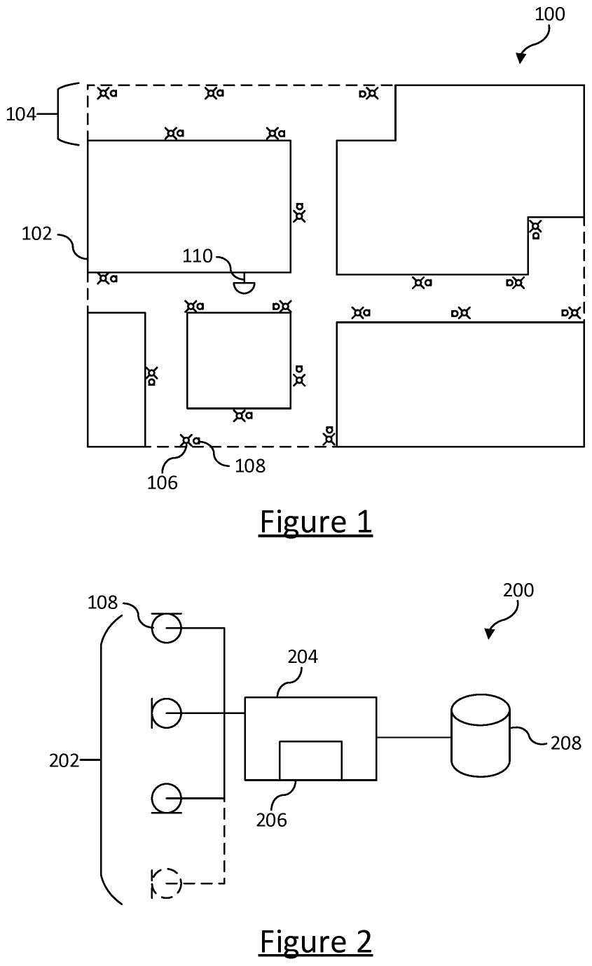

FIG. 1 shows a schematic illustration of an environment 100 in which an audio based monitoring system is distributed comprising a network of microphones 108. The environment 100 could be an outdoor or indoor environment. For example the environment 100 may comprise a series of streets and buildings, or a series of corridors and rooms. FIG. 1 shows a layout that could represent as either of these environment types. For the sake of illustration FIG. 1 will be described by way of example in relation to a map section showing streets and buildings. It should be understood that in reality the environment in which the system of the present invention is implemented may consist of an outdoor environment, an indoor environment, a combination of both of these types of environment, and similarly may include any other type of environment in which such a system may be implemented.

The environment 100 may comprise a number of buildings 102 separated by a number of thoroughfares such as streets or footpaths 104. The environment may span an area of the scale of at least one city block, one building, one town square, one street, one school campus, or one town. That is to say the environment is at least bigger than one room. Each street 104 is equipped with a lighting system comprising one or more luminaires 106. Each luminaire 106 also comprises one or more co-located sensors. These comprise at least acoustic sensors in the form of microphones 108, with at least one microphone 108 per luminaire 106. The system may also include dedicated sensors for sound monitoring only, i.e. standalone microphones 108 that are not incorporated into luminaires 106. However, for illustrative purposes in FIG. 1 all microphones 108 have been depicted alongside or incorporated into a co-located luminaire 106. It should be understood that one of the advantageous aspects of certain embodiments lies in taking advantage of such co-located microphones 108 and their dense distribution resulting from co-existing within a system such as a lighting system. A finer level of granularity of sensors 108 can be achieved by adding further sensors to complement those incorporated within another system such as a lighting system.

A similar situation can be envisioned as existing within a building environment, where corridor lighting systems comprising numerous luminaires 106 may be similarly equipped with co-located microphones 108, and/or where stand-alone microphones 108 may be deployed. It should be appreciated that microphones used may be any one of a plurality of different possible types of microphone, such as omnidirectional, unidirectional, or bidirectional microphones etc. Such directional microphones may be used to provide further information about the spatial distribution and directionality of any detected sound content and the causal event.

The environment 100 includes one or more sources 110 of environmental sounds. For example, these may comprise one or more of a fire alarm, burglar alarm, etc. as shown positioned on the outside of building 102. Such sources 110 often output the same environmental sound repeatedly. That is to say the same source will produce the same type of sound (e.g. as characterized by the frequency profile of the sound), repeatedly over time. In some instances the sound may be repeated at regular and predictable intervals, other environmental sounds may not be as predictable. It is these recurring sounds within the environment 100 that are used in the method described herein. The environmental sound is a sound emitted from a source within the environment 100, or from a source at least in audible proximity to the environment 100. The source of the environmental sound may be across the street, in the next street, on the next block, on the other side of the building, etc. from the microphone at which it is detected. The environmental sound itself may also be referred to as an ambient or incidental sound, i.e. a sound originating from the surroundings of the microphones 108 independently of the acoustic monitoring system. I.e. the environmental sound is not introduced by the acoustic monitoring system nor any provider or operator of the acoustic monitoring system, not any party affiliated with them. Rather, it originates either from nature or a source introduced by an independent third party.

There are multiple manners of determining that such environmental sound is recurring. For example: a sound may be detected, analyzed and categorized (e.g. a clock ticking or a church bell ringing can be categorized as a sound that is suitable and an instance of such sound may be used as a reference sound, whereas a dog barking or an airplane flying over may be categorized as not suitable and may be ignored), a sound may be detected multiple times and this may lead to the conclusion that each occurrence is an instance of a suitable recurring sound (e.g. a cuckoo's clock making a cuckoo sound every hour, such that a reference sound is captured when the sound has been captured at least, for example, 10 times), the microphone may be placed at a location of which it is known that a recurring sound may be measured at such location (e.g. the microphone is mapped to an address and a lookup function determines that a school is nearby which is expected to sound an audible bell signal when class starts, such that the bell signal is used as a referene sound), or a user may provide input, for example by confirming determination of a sound to be recurring or selecting a recurring sound to be monitored from a list of common recurring sounds or from sounds that were detected e.g. in the last 24 hours.

FIG. 2 is a schematic diagram showing the acoustic monitoring system 200. The system 200 comprises a network 202 of connected microphones 108 for detecting environmental sound content. Each of these microphones 108 may or may not be incorporated into a respective luminaire 106 of a co-existing lighting system. The network of microphones 202 is connected to controller 204. The microphones may be connected in any suitable configuration such the sound content detected by one of the plurality of microphones 108 is able to be made available to the controller 204. This may be via a series of connected microphones, or individually connected microphones, or any other microphone configuration suitable to carry out the purpose of delivering detected environmental sound content to the controller 204. Said connections may be wired connections, wireless connections, or a combination of the two. The wireless connections may use any wide-area network technology such as the internet, a cellular network (e.g. 3GPP network), and/or a dedicated city control network; or a combination of a wide area network with any one or more local area networks, e.g. using a wireless access technology such as Wi-Fi, ZigBee or Bluetooth, or the like, or a wired technology such as Ethernet. The controller 204 may thus be configured to receive the sound content via any suitable communication link or network or combination thereof.

The controller 204 further comprises a sound recognition engine 206. The controller 204, including the sound recognition engine 206, may be implemented in software stored on one or more storage units employing one or more storage media (e.g. magnetic, electronic, or optical media), and arranged to run on one or more processors. Alternatively, an implementation wholly or partially in hardware circuitry is not excluded. Either way the controller 204 and its sound recognition engine 206 may be implemented on one device (in the same housing) or across multiple devices, e.g. embedded in the luminaire or microphone 108 or at a central server, or a combination of such approaches.

The sound recognition engine 206 receives sound content from one of the microphones 108 (via any of the above means). The sound recognition engine 206 may then determine that the environmental sound is a recurring environmental sound. That is to say, the environmental sound is a sound which is repeated within the environment.

In embodiments this comprises identifying the type of source of the environmental sound content received. For example, the environmental sound source may be a fire alarm, a church bell, a bus at a bus stop, a person shouting, an ice cream van jingle, etc. The sound recognition engine 206 can then identify the type of source of the environmental sound and thus determine whether the sound is suitable to be used to create a reference signal. Where a suitable environmental sound is a sound which is consistent in frequency and amplitude (in decibels) between instances. An environmental sound is a sound which originates from a source other than the system comprising the network of microphones 108. That is to say, the environmental sound originates from a third party source which is not a part of the system or party performing the performance tracking.

In an example the sound recognition engine 206 may be used to determine the type of source of the environmental sound, i.e. to recognize whether the source and therefore the environmental sound is of a type that is suitable to be used as a reference sound. The recognition engine 206 determines recurring environmental sounds that can be used to provide a reference signal. The suitability of the environmental sound depends on the type of source of the environmental sound. That is to say, of the examples of environmental sounds given above, the recognition engine 206 may determine that the sounds of a person shouting and an ice cream van jingle are not suitable for use in creating a reference sound. This may be because the sound of a person shouting is not consistent enough, either in frequency or in amplitude, to use as a reference sound for measuring the performance of the microphone 108. I.e. it is likely to be different from one instance to the next as detected by the microphone, and may subsequently be determined not to be a recurring environmental sound at all.

Similarly the ice cream van jingle is also likely to not be suitable to be used for capturing a reference signal. This is because even though the jingle is likely to be consistent with regard to frequency, the sound is emitted from a source which may not be positioned in the same location relative to the microphone's position at each instance of the jingle being played out. Thus there will likely be inconsistencies introduced as a result of the change in distance between the microphone and the ice cream van. The type of source has a different location relative to the environment when the source is emitting any subsequent instance of the environmental sound.

An example of a suitable environmental sound is a church bell. The audio characteristics of a church bell ringing will be recognized using sound recognition, where the church bell sound can then be identified as a church bell and determined to be suitable for use in creating the reference signal. For example, the sound emanates from a source which does not move relative to the environment, and thus the sound will not be expected to change in amplitude outside of known conditions such as changes in weather. For instance the source is not an ice cream truck, which may never park in the same place twice.

The above described use of the recognition engine may thus also be used to determine whether a detected first instance of an environmental sound is a recurring environmental sound based on the type of source. When recognizing a source of the environmental sound as a church bell it is fair to assume that the sound will be repeated within the environment. It may even be possible to determine the time at which to expect a subsequent instance of the environmental sound, i.e. every hour. That is to say the determining may in embodiments comprise using sound recognition to recognise that the environmental sound is a sound which is repeated periodically.

Further to this, the recognition engine 206 may also be used to detect subsequent instances of the same environmental sound. If a sound is not repeated periodically, but is expected to be repeated based on the identified type of source, the recognition engine may simply detect any subsequent instances of the same environmental sound used to create the reference signal based on the sound signature or sound characteristics of the same environmental sound. The sound signature may comprise a frequency profile of a sound. Sound recognition algorithms in themselves are known to a person skilled in the art.

Once the environmental sound is determined to be a recurring environmental sound, a reference signal can be captured. The controller 204 thus captures a reference signal from the detected first instance of the environmental sound. The reference signal may be captured in the form of an exact recording of the first instance, or could be formed by extracting a representation (i.e. a spectrum), and capturing that representation. That is to say the reference signal could be captured as a sound recording based on the first instance of the environmental sound, or as a representation of the first instance of the environmental sound, e.g. a spectrum. The reference signal may then be created by storing the sound spectrum of the first instance of the environmental sound.

The reference signal then becomes a definition of the environmental sound, as received at the microphone, at the time of the detected first instance of the environmental sound. Upon detecting subsequent instances of the same environmental sound (determined as explained above), the reference signal may be compared against the subsequent instance. This may involve a corresponding representation (e.g. sound spectrum) of the subsequent instance of the environmental sound being created for the purpose of comparison to the reference signal. In embodiments, the detected subsequent instance may be compared directly to the reference signal without an intermediate step of creating a sound spectrum. A sound spectrum may be created by analysing each of the parameters of amplitude and/or the frequency (e.g. frequency spectrum) over time for any one instance of the environmental sound.

It is thus possible to determine an indication of the performance of the microphone. Differences between the subsequent instance of the environmental sound and the reference signal can thus signify degradation in the microphone's recordings. This degradation may be due to a number of factors. These factors significantly increase in number when considering an outdoor environment versus an indoor environment.

The controller 204 is further connected to a database 208. Database 208 may be a database that forms part of the system including the controller 204 and the microphones 108. In an example the database 208 may be a third party database.

It should also be understood that controller 204 and database 208 need not be separate entities in the strict sense as shown in FIG. 2, and may or may not be similarly structured, located, owned, networked, connected, and distributed. Controller 204 and database 208 may or may not be separate entities and may or may not be embodied within the same processor and storage medium. It should also be understood that the modules and elements of the controller 204, sound recognition engine 206, and database 208 may also be executed in a distributed manner. That is to say the sound recognition engine, storage medium, and any other components required to carry out the actions of the microphone performance tracking system may be distributed over a computer network and thus may be executed within any part of that network.

The database 208 may store data relating to secondary or specific contextual information and data from other sensors, e.g. related to the weather or traffic conditions. This data can be taken into account when making the comparison against the reference signal. For example, information about the weather, such as wind conditions, may enable any sound degradation due to the wind to be accounted for.

Such environmental conditions may be accounted for and considered in the comparison process. For example, differences between the reference signal and the subsequent instance of the environmental sound are considered to be less meaningful or less worrying than they might have been otherwise (i.e. by instigating a larger tolerance threshold for differences in amplitude during this comparison, therefore allowing greater differences to exist before a microphone is considered to be underperforming).

In another example, the strong wind might be accounted for by not using subsequent instances of the environmental sound which have been captured in such weather conditions. That is to say, upon receiving an indication from the database 208 that extreme weather conditions are present at the location of the microphone, any subsequent instances of the environmental sound captured during this time will not be used to assess the performance of the microphone. Thus this particular subsequent instance is skipped from the comparison stage in favor of a later subsequent instance, or the resulting indication of performance is disregarded or given a low priority or importance. Thus the algorithm performing the comparison may select a subsequent instance of the environmental sound from a moment in time at which the contextual conditions at the microphone are similar or close to the conditions in which the first instance of the environmental sound was measured.

Subsequent instances after any particularly adverse condition has subsided may be given a higher priority or greater importance with regard to the indication determined therefrom. This may be because a greater time period has elapsed between comparisons as a result of skipping an instance of the environmental sound for comparison, or because it is more likely that the microphone 108 is damaged after such adverse conditions. For example, the microphone may have had water, dust, debris, etc. introduced into the internal workings. The microphone may have been moved or physically damaged by an impact or force (e.g. hit by leaves, branches, birds, the wind, etc.). The microphone may have been distorted e.g. by the sun melting, breaking down, or warping components, or by ice forming and putting pressure on the structure or components of the microphone. As such it may be that the comparison takes into account environmental conditions at the microphone at the time of the subsequent environmental sound relative to the environmental conditions at the microphone at the time of the first instance of the environmental sound, i.e. relative to the time when the reference signal was captured. Thus the controller 204 can take into account during the comparison whether the microphone is in a location particularly exposed to the weather (e.g. wind, rain, sun), or in a location where traffic levels, and therefore noise levels, fluctuate at different times and on different days (e.g. 9 a.m. vs 11 a.m. or weekday vs weekend), etc.

The determined indication of performance of the microphone may comprise outputting an indication that there has been a detected change in performance (i.e. a reduction or an increase). Or the indication may comprise an indication that there has been no detected change in performance. This determination may be made based on comparing parameters of the sound spectrum of the environmental sound to parameters of the sound spectrum of the reference signal. I.e. by considering differences in the frequency response of the microphone, or the amplitude response of the microphone, or both.

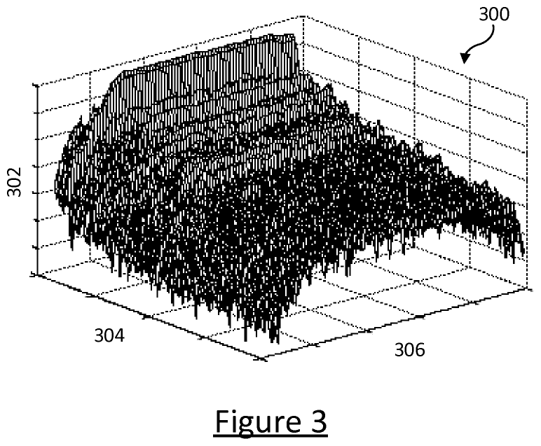

FIG. 3 shows an example of a sound spectrum 300. The sound spectrum 300 having been created by analysing each of the parameters of amplitude 302 over time 306, and frequency 304 over time 306. The analysis may be performed at intervals within a period of time over which the environmental sound is detected. That is to say that, frequency and amplitude analysis are performed at various time intervals within the time period over which the environmental sound is detected. For example, this may be once every second, twice every second, five times every second, ten times every second, etc. This may be expressed as once every 0.4 seconds, once every 0.2 seconds, once every 0.1 seconds, etc.

The analysis intervals may be evenly spaced over the period of time which the environmental sound is detected. Alternatively they may be performed at intervals within the period of time with a density dependent on the degree of change in one of the parameters of the sound spectrum 300. That is to say the analysis may be performed more often at particular points within the time period of the environmental sound where the frequency 304 or amplitude 302 of the environmental sound is changing the most, or has the greatest gradient with respect to time 306.

The comparison, at least in part, between the subsequent instance of the environmental sound and the reference signal may comprise a comparison of respective sound spectra. That is to say, a sound spectrum created from the first instance of the environmental sound is compared to a sound spectrum created from a subsequent instance of the same environmental sound. This may comprise a comparison of amplitude 302 of specific frequency characteristics 304 of the environmental sound. For example a microphone may lose sensitivity to high frequency sounds, and/or low frequency sounds, such that only these frequencies change in amplitude from one spectrum to the next. The microphone may become damaged or degraded such that it can no longer optimally detect particular frequencies, or can no longer detect particular frequencies at all.

In an example, the spectrum of an environmental sound may change in such a way as to shift all the frequencies of the environmental sound in a uniform way. For example the environmental sound may maintain the same shaped frequency profile, but the frequency values themselves may be shifted up or down relating to an overall comparison of frequency characteristics 304 of the environmental sound.

Alternatively, the frequency values themselves may maintain the same values, but the amplitudes 302 of each frequency 304 at each point in time 306 may be reduced. For example, the microphones amplitude response may become damped in some way.

It may be possible to determine from the particular type of difference between sound spectra which type of damage or degradation has occurred at the microphone 108. E.g. an overall reduction in amplitude of a sound spectrum may indicate that the microphone has become damped or covered in some way. A drop in sensitivity for a particular frequency range may indicate physical damage to the microphone or its components.

The indication of performance may be given as a level of performance based on the magnitude of the detected change in performance. That is to say where a significant change is noticed, either in the amplitude or any given frequency or range thereof, the indication may be output as a numerical value representing the level of performance. E.g. a change in performance of 0% may be level 1 and correspond to no deviation, 0-5% may be level 2 and correspond to a low amount of deviation, 5-10% may be level 3, etc. up to 50%+ which may correspond to a very high deviation etc. It should be understood that these levels are simply examples and that different levels of performance can be set to any suitable range as required.

In an example, the indication or level of performance may be output as (or including) a notification comprising a level of importance. Thus a messaging system for responsible in forming parties may be provided to receive messages with contextual information about the performance of the acoustic sensor. The level of importance may indicate the amount of attention that should be paid to a particular level of performance or indication of performance. For example, level 1 may correspond to an output notification comprising ‘negligible’ or ‘expected’. Level 3 may correspond to ‘worrying’. Level 5 may be ‘critical’. The level of importance may be adjusted to account for the specific conditions at the microphone being tracked. That is to say that each microphone 108 may be given different associations between levels of performance and level of importance based on the specific conditions at that microphone, e.g. to account for the weather conditions or the level of risk within the immediate area of the location of the microphone. For example, a higher level of importance may be assigned if the microphone is positioned in an area where incidents often occur, and thus an accurate measure of sound may be vital for evidence or situation tracking purposes. As another example, the microphone may be positioned in a particularly exposed position, and thus greater levels of interference due to e.g. wind, are expected. The above may be associated with the tolerance threshold for differences mentioned above. The result may be that actions at a microphone may be prioritized if maintenance is needed for a ‘critical’ performance issue.

The microphone 108 may also be identified to the controller 204. This identification may be in the form of an identifier of the microphone and subsequently related to a location of the microphone, i.e. known from another source (e.g. a database 204 of microphone locations), or directly with respect to the location of the microphone at which the environmental sound was detected. The location may be signified to the controller in the form of co-ordinates such as Cartesian co-ordinates of a floorplan, global positioning (GPS) co-ordinates, etc. The microphone location may then be used to retrieve relevant secondary or specific contextual information from database 204.

In examples, a combination of different environmental sounds can be detected and used at different moments in time to analyse any one microphones' performance. That is to say more than one different environmental sound may be used to form a different reference signal in concurrent performance tracking processes. This may be advantageous if subsequent instances of a single environmental sound are separated by long periods of time. The controller can be configured to track the performance over time for one microphone, or a group of microphones. The group of microphones may be located close together such as to be influenced by similar environmental conditions. The controller may be further configured to identify and track trends in the performance of one or more microphones.

The controller 204 thus uses an environmental sound while striving to compare instances of the environmental sound detected within a constant or semi-controlled environment. For example, the environment may be controlled in the sense that the detecting is performed at the exact location where the microphone is placed, during a specific time. For example, the detecting may be performed at midnight since at this time church bells always ring, and in this particular area the background conditions/sounds (e.g. traffic or weather) are relatively constant. Third party data sets (e.g. weather, traffic information, city agenda, crowd density, etc.) may provide the system with additional contextual information to keep track of the background noise and keep the testing environment as close to a consistent state as possible.

To continuously check the microphone's performance, subsequent environmental sounds may be captured on a regular basis (e.g. monthly, daily, etc.), and a sound spectra created each time. The reference signal is then compared with each subsequent spectra and a malfunctioning microphone can be detected. The comparison may be performed at the time of detecting the subsequent instance of the environmental sound, or at a later time in combination with other instances.

It will be appreciated that the above embodiments have been described only by way of example. Other variations to the disclosed embodiments can be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. A single processor or other unit may fulfil the functions of several items recited in the claims. The mere fact that certain measures are recited in mutually different dependent claims does not indicate that a combination of these measures cannot be used to advantage. A computer program may be stored and/or distributed on a suitable medium, such as an optical storage medium or a solid-state medium supplied together with or as part of other hardware, but may also be distributed in other forms, such as via the Internet or other wired or wireless telecommunication systems. Any reference signs in the claims should not be construed as limiting the scope.

1. A method of tracking the performance of a microphone forming part of an audio based monitoring system, comprising a network of microphones distributed throughout an environment the method comprising:
detecting a first instance of an environmental sound at the microphone;
determining that the environmental sound is a recurring environmental sound;
capturing a reference signal from the detected first instance of the environmental sound;
detecting a subsequent instance of the same environmental sound at the same microphone; and
comparing at least in part the subsequent instance of the environmental sound to the reference signal to determine an indication of the performance of the microphone.

2. The method of claim 1, wherein the comparison is performed by analyzing an amplitude and/or frequency over time for the first and subsequent instances of the environmental sound.

3. The method of claim 2, wherein the analysis is performed at intervals within a period of time over which the environmental sound is detected.

4. The method of claim 3, wherein the intervals are evenly spaced over the period of time.

5. The method of claim 1, wherein the reference signal is created by storing a sound spectrum of the first instance of the environmental sound.

6. The method of claim 1, wherein the environment spans an area of the scale of at least one city block, and/or one building, and/or one street, and/or one town square, and/or one school campus, and/or one town.

7. The method of claim 1, wherein said determining includes using sound recognition to identify a type of a source of the environmental sound.

8. The method of claim 7, wherein the type of source does not have a different location relative to the environment when emitting the subsequent instance of the environmental sound than when emitting the first instance.

9. The method of claim 1, wherein said determining comprises using sound recognition to recognize that the environmental sound is a sound which is repeated periodically.

10. The method of claim 1, wherein the subsequent instance of the environmental sound is recognized using a sound recognition algorithm applied to recognize a sound signature of the first instance of the environmental sound.

11. The method of claim 10, wherein the sound signature comprises a frequency profile.

12. The method of claim 1, wherein the comparison comprises comparing sound spectra of the first and subsequent instances of the environmental sound.

13. The method of claim 1, wherein the comparison takes into account environmental conditions at the microphone at the time of the subsequent environmental sound relative to environmental conditions at the microphone at the time of the first instance of the environmental sound.

14. A computer program product comprising code embodied on computer-readable storage and configured so as when run on a computer system to perform the operations of claim 1.

15. A device for tracking the performance of a microphone forming part of an audio based monitoring system comprising a network of microphones distributed throughout an environment, the device comprising an input for receiving an audio signal from the microphone and a processor configured to:
detect a first instance of an environmental sound at the microphone;
determine that the environmental sound is a recurring environmental sound;
capture a reference signal from the detected first instance of the environmental sound;
detect a subsequent instance of the same environmental sound at the same microphone; and
compare at least in part the subsequent instance of the environmental sound to the reference signal to determine an indication of the performance of the microphone.
